(19) United States
(12) Patent Application Publication
(10) Pub. No.: US 2004/0088216 A1
(43) Pub. Date: May 6, 2004

(54) Methods and systems for conducting electronic commerce

(76) Inventor: Rajesh N. Bangalore, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/286,248

(22) Filed: Oct. 31, 2002

(51) Int. Cl. G06F 17/60

(52) U.S. Cl. 705/14

(57) ABSTRACT

A computer-implemented method for conducting an electronic commerce transaction between a buyer and a seller is disclosed. The electronic commerce transaction is conducted via a telecommunication network. The method includes receiving identity information pertaining to the buyer and ascertaining a set of financing terms associated with the buyer. The set of financing terms includes at least a first interest rate, a triggering condition, and a second interest rate lower than the first interest rate. The triggering condition pertains to at least one parameter associated with the electronic commerce transaction. The method also includes ascertaining whether the electronic commerce transaction satisfies the triggering condition. If the triggering condition is satisfied by the electronic commerce transaction, the method includes applying the second interest rate to a financing amount, at least a portion of the financing amount being attributable to the electronic commerce transaction, else applying the first interest rate to the financing amount if the triggering condition is not satisfied by the electronic commerce transaction.

### BACKGROUND OF THE INVENTION

With the advent of reliable and secure telecommunication systems, electronic commerce or e-commerce has emerged as a major method of conducting commercial transactions. In electronic commerce, buyers and sellers can conduct buying and selling activities via one or more telecommunication systems using a variety of telecommunication devices such as computers, voice telephones, personal digital assistants (PDA), or data-enabled telephones.

Because buyers and sellers conduct e-commerce transactions remote from one another, the use of a credit facility is essential to facilitate the completion of a transaction. In a typical e-commerce transaction, the buyer typically indicates his desire to purchase goods as well as his intent to pay for the goods purchased using an established credit facility. The credit facility may represent, for example, the buyer's established account with the seller, the buyer's credit with a commercial credit facility such as a credit card company, a bank, or the buyer's pre-arranged financed account, which may be arranged with the seller or a commercial credit operation acceptable to the seller.

To facilitate discussion, FIG. 1 illustrates relevant components in a typical e-commerce transaction that also utilizes a finance facility. In FIG. 1, the buyer 102 is shown conducting an e-commerce transaction with a seller's secure e-commerce system 104 via a terminal 106, which is connected to the Internet 108. Through terminal 106, buyer 102 may be able to access the seller's secure e-commerce system 104 to make selections, and to arrange for a purchase of the selected items. E-commerce system 104 tracks the buyer's personal information as well as the information pertaining to past and current transactions pertaining to buyer 102 in a buyer database 110.

Once buyer 102 finalizes his selection, seller's e-commerce system 104 may call upon inventory module 112 to check for the availability of the selected items, shipping module 114 to arrange for shipping to the buyer's shipping address. If buyer 102 indicates that he wishes to finance the purchase, a finance module 116 may be called upon to debit the buyer's finance account, to arrange for a payment schedule, and, in some cases, to facilitate payment to the seller, if the financing is undertaken by a third party.

The use of financing thus enables the buyer to conveniently make purchases, to track payment in a centralized account, and to spread the purchase price over a period of time. In general, a typical finance arrangement involves the repayment of the principal amount and an interest amount over some period of time. The principal amount represents the original purchase price whereas the interest amount represents the interest payment due to the finance company for granting credit to the buyer. Over time, it has been found that financing activity is both a profit center for the seller and/or the commercial credit company granting the credit, and a competitive advantage to the seller in retaining buyers and in increasing the sales volume since financing allows the buyer to purchase additional goods and services on credit.

Generally speaking, the finance terms are known to both the seller and the buyer, or should be made known to the buyer, prior to purchase. A number of consumer protection laws and regulations prohibit sellers from arbitrarily increasing the interest rate and/or to make the finance terms more onerous after the transaction is concluded. As a result, historically, the finance terms were kept unchanging over time and/or across different transactions in a given account. Furthermore, credit grantors generally advertise and keep the finance terms (such as the interest rate) the same for all buyers irrespective of credit rating, purchase pattern, the purchase amount, and the like, to simplify the accounting.

In some cases, some preferred buyers may be given special finance terms when their accounts are established, e.g., due to the importance of the buyer to the seller or due to the buyer's taking advantage of a special promotion which lowers the finance rate. However, even for these preferred buyers, the finance terms tend to stay constant over time and/or from transaction to transaction once the account is set up. In other words, as long as the buyer's buying activity does not exceed the established credit limit (in which case, the buyer is prohibited from making the additional purchase), the finance terms are static for all the purchases under the credit limit. In view of these historical practices, it occurs to the inventor herein that finance terms have been under utilized as a way to entice a new or existing buyer to increase buying and/or to steer the buyer's purchase toward a particular product or type of product.

### SUMMARY OF THE INVENTION

The invention relates, in one embodiment, to a computer-implemented method for conducting an electronic commerce transaction between a buyer and a seller. The electronic commerce transaction is conducted via a telecommunication network. The method includes receiving identity information pertaining to the buyer and ascertaining a set of financing terms associated with the buyer. The set of financing terms includes at least a first interest rate, a triggering condition, and a second interest rate lower than the first interest rate. The triggering condition pertains to at least one parameter associated with the electronic commerce transaction. The method also includes ascertaining whether the electronic commerce transaction satisfies the triggering condition. If the triggering condition is satisfied by the electronic commerce transaction, the method includes applying the second interest rate to a financing amount, at least a portion of the financing amount being attributable to the electronic commerce transaction, else applying the first interest rate to the financing amount if the triggering condition is not satisfied by the electronic commerce transaction.

In another embodiment, the invention relates to a computer-implemented method or conducting an electronic commerce transaction between a buyer and a seller. The electronic commerce transaction is conducted via a telecommunication network. The method includes receiving identity information pertaining to the buyer. The method also includes ascertaining a set of financing terms associated with the buyer. The set of financing terms includes at least a first financing term, a plurality of triggering conditions, and a plurality of alternative financing terms. Each alternative financing term in the plurality of alternative financing terms is more favorable to the buyer than the first financing term. The method also includes ascertaining whether the electronic commerce transaction satisfies at least one triggering condition of the plurality of triggering conditions. The method additionally includes applying, if the electronic commerce transaction satisfies the at least one triggering condition of the plurality of triggering conditions, an alternative financing term associated with the at least one triggering condition satisfied by the electronic commerce transaction to at least a portion of a financing amount attributable to the electronic commerce transaction, the alternative financing term associated with the at least one triggering condition satisfied by the electronic commerce transaction being an alternative financing term of the plurality of alternative financing terms, else applying the first financing term to the financing amount.

In yet another embodiment, the invention relates to an article of manufacture comprising a program storage medium having computer readable code embodied therein, the computer readable code being configured for conducting an electronic commerce transaction between a buyer and a seller. The electronic commerce transaction is conducted via a telecommunication network. The program storage medium includes computer readable code for receiving identity information pertaining to the buyer. There is further included computer readable code for ascertaining a set of financing terms associated with the buyer, the set of financing terms including at least a first interest rate, a triggering condition, and a second interest rate lower than the first interest rate, the triggering condition pertaining to at least one parameter associated with the electronic commerce transaction. Additionally, there is included computer readable code for ascertaining whether the electronic commerce transaction satisfies the triggering condition. Furthermore, there is included computer readable code for applying, if the triggering condition is satisfied by the electronic commerce transaction, the second interest rate to a financing amount, at least a portion of the financing amount being attributable to the electronic commerce transaction, else applying the first interest rate to the financing amount if the triggering condition is not satisfied by the electronic commerce transaction.

In still another embodiment of the present invention, the invention relates to a computer-implemented method for conducting an electronic commerce transaction between a buyer and a seller, the electronic commerce transaction being conducted via a telecommunication network. The method includes receiving identity information pertaining to the buyer and ascertaining, based on past transactions conducted by the buyer with the seller, whether the buyer qualifies as a volume buyer. If the buyer qualifies as the volume buyer based on the past transactions, there is included offering an incentive redeemable by the buyer in the electronic commerce transaction.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates, to facilitate discussion, relevant components in a typical e-commerce transaction.

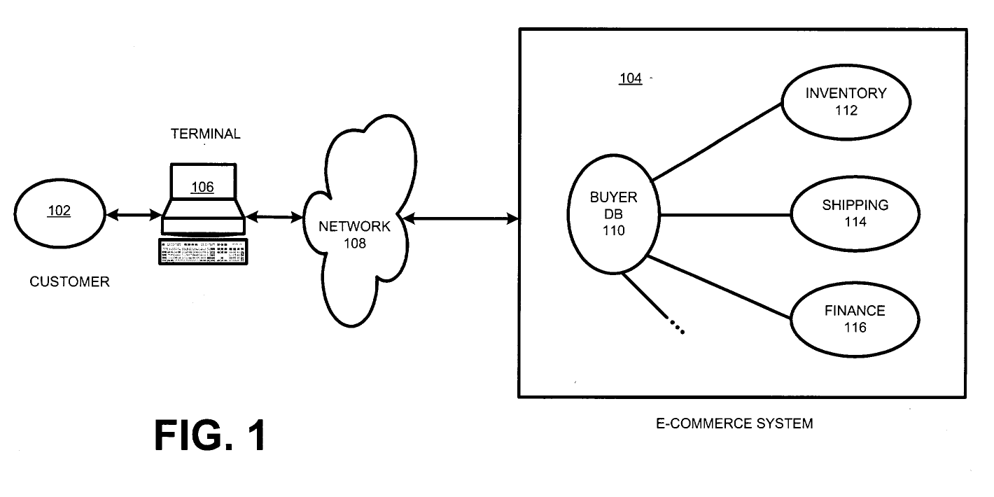

FIG. 2 is a simplified flowchart illustrating, in accordance with one embodiment of the present invention, the exemplary steps for conducting the electronic commerce transactions.

FIG. 3 is an exemplary table showing three different buyers having three different default financing terms in accordance with one embodiment of the present invention.

FIG. 4 is a flowchart illustrating, in accordance with one embodiment of the present invention, the computer-implemented group purchase incentive technique.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In one embodiment, the present invention relates to a computer-implemented method for conducting an electronic commerce transaction between a buyer and a seller through a telecommunication network. A given buyer, whether a new buyer or a returning buyer, may be presented with a set of financing terms designed to reward and/or encourage certain buying behaviors, such as purchasing a certain type of item or certain specific items, buying more than a threshold amount, and the like. In one embodiment, the buyer's log-in information is employed to ascertain a set of financing terms associated with the buyer.

The set of financing terms preferably includes a first financing term, a triggering condition, and at least a second financing term more advantageous to the buyer than the first financing term. For example, the buyer may be offered a lower interest rate as the more advantageous second financing term if the transaction satisfies the triggering condition. In this example, the triggering condition may be a certain dollar amount threshold, above which the buyer would be entitled to the lower interest rate. If the transaction does not meet the requirements of the triggering condition, the higher interest rate (i.e., the first financing term) applies.

The triggering condition itself may be based on any number of business rules as may be desirable to the seller. For example, some sellers may wish to increase the selling volume of a certain item (e.g., a particular model of laser printer) or a particular type of item (e.g., all laser printers). In this case, the triggering condition may be the purchase of either the particular model of the laser printer in the first case or any laser printer in the second case.

If the triggering condition involves one or more threshold values, the threshold values may be set individually for each buyer. For example, a corporate buyer may be required to meet a higher threshold before being deemed eligible for the more attractive financing terms while an individual buyer may have a lower threshold associated with their triggering condition. Likewise, the financing term or terms (e.g., interest rate, the amount of time available to pay off the balance, the grace period, and the like) may be set individually for each buyer or each class of buyers. Additionally, the threshold value(s) associated with a triggering condition and/or the advantageous financing terms that apply if the triggering condition is met, may be set based on an analysis of the buyer's past behaviors. For example, if it is known that a certain buyer always has a need for ten boxes of letter-sized paper every four weeks, it is unnecessary to offer the more attractive financing term to entice that buyer to purchase letter-sized paper. As another example, a buyer who had, at one time, been a high-volume buyer but has recently reduced his purchase amount, may be enticed to increase his purchase by being offered an attractive financing term using a triggering condition that is set slightly above his current reduced buying level.

In accordance with another embodiment of the present invention, there may be multiple triggering conditions and multiple associated alternative financing terms, all of which may be more attractive than the default financing term assigned to the buyer, in order to entice the buyer to engage in a specific buying behavior. For example, a buyer may be offered a reduction of 0.5% in his APR (Annual Percentage Rate) if his purchase during the current transaction exceeds $1,000 (the exemplary first triggering condition). If the buyer purchases more than $2,000 for the current transaction (the exemplary second triggering condition), another reduction in the APR may apply and/or the buyer may be offered an option to defer payment for six months and/or the buyer may be offered free shipping and/or any other reward. As before, the various triggering conditions and associated alternative financing terms and/or other rewards may be based on an analysis of a particular buyer's past buying behavior. Of course, there may be as many triggering conditions as desired by the seller and the rewards may vary widely according to the business rules set out by the seller.

In accordance with another embodiment of the present invention, the buying behavior of the buyer during the current electronic commerce transaction may also be taking into account in setting the appropriate triggering condition(s) and/or alternative financing term(s). In this manner, data analysis to set the appropriate triggering condition(s), and alternative financing term(s) may include data mining of the buyer's past buying behavior, the buyer's personal information and credit worthiness, and/or the buyer's buying behavior in the current electronic commerce transaction.

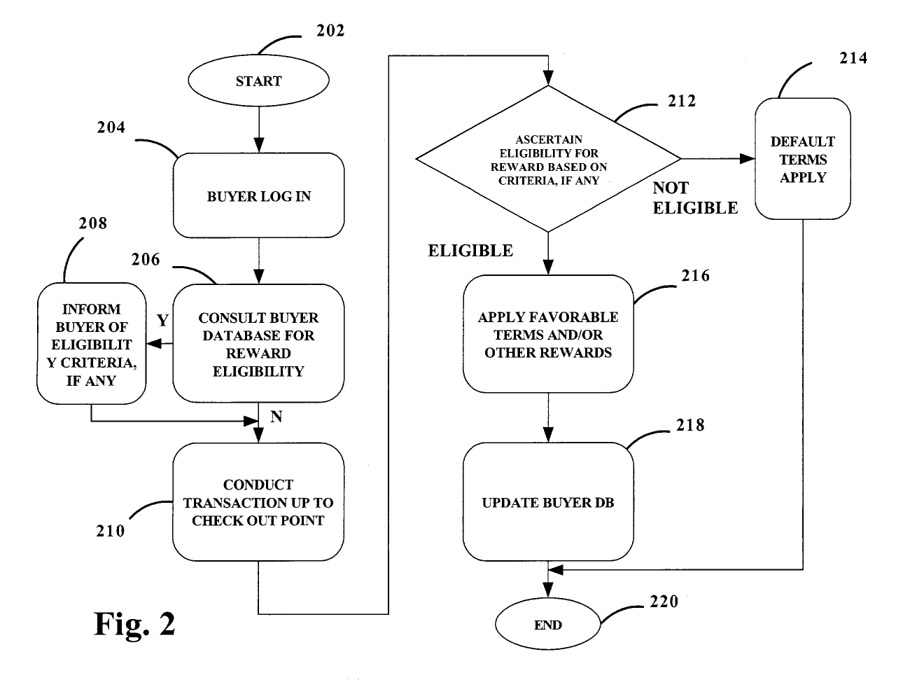

The features and advantages of the present invention may be better understood with reference to the drawings and discussions that follow. In FIG. 2, there is shown a simplified flowchart illustrating the exemplary steps for conducting the electronic commerce transactions in accordance with one embodiment of the present invention.

In FIG. 2, the buyer may identify himself to the electronic commerce system by logging in, in step 204. Generally speaking, in order to take advantage of the financing option, a buyer must have registered and be approved in advance. Thus, if the buyer is new, there may be a registration and approval process that precedes step 204. However, the process of applying for credit and receiving approval therefore is well known.

In step 206, the electronic commerce system consults a buyer database to obtain information pertaining to rewards eligibility for the buyer identified via step 204. In step 206, the default financing term for the buyer may be obtained. For example, such default financing term may include the default APR, the default time to pay off the balance, the default minimum monthly payment, and the like.

Furthermore, a triggering condition or multiple triggering conditions and associated financing terms are also obtained in step 206. As mentioned earlier, the triggering conditions and associated alternative financing terms may be based on individual characteristics and credit worthiness of the buyer. Furthermore, the triggering conditions and alternative financing terms and/or any other rewards associated with the triggering conditions may be based on data analysis of the buyer's buying behaviors in the past.

In accordance with one embodiment of the present invention, the buyer may be informed of the eligibility criteria for the more favorable financing terms and/or other rewards, along with the required triggering conditions prior to the selection phase of the electronic commerce transaction. That is, the buyer may be enticed into making a particular purchase or meeting a particular dollar threshold value by being informed even as the buyer begins the process of browsing through the goods and services offered and selecting the desired goods and/or services. This is shown in step 208.

In step 210, the selection phase of the electronic commerce transaction is conducted by the buyer including the conduct of the purchase transaction up to the checkout point. In one embodiment of the present invention, the buyer's selection data may also be analyzed in order to formulate an appropriate triggering condition and/or alternative financing terms (and/or other rewards) in order to guide the buyer toward a particular product or service, or buying behavior desired by the seller. For example, if the buyer selects a laser printer, the electronic commerce system may use that information to formulate a triggering condition that states that, if the buyer also purchases an additional ink cartridge and a box of paper, the buyer does not have to make any payment for six months. As a further example, another triggering condition may state that, if the buyer purchases a dozen ink cartridges along with the previously selected laser printer, the buyer may get a reduction in the APR and/or a coupon for free shipping. In another embodiment, the analysis may alternatively or additionally be based on the type of service or goods or class of service or goods selected by the buyer for purchase.

In step 212, the electronic commerce transaction is tested to see whether it satisfies one or more triggering conditions for an alternative financing term. If the current electronic commerce transaction does not satisfy a triggering condition for a more advantageous alternative financing term, the default financing term applies. This is shown in step 214. However, if the current electronic commerce transaction satisfies one or more triggering conditions, the more favorable alternative financing terms and/or rewards would apply. This is shown in step 216.

If the buyer satisfies multiple triggering conditions, the selection of which alternative financing term to apply may depend on the business rules of a particular seller. In a preferred embodiment, the buyer would be offered the most advantageous alternative financing term possible based on the set of triggering conditions that the buyer's current electronic commerce transaction satisfies. In step 218, the buyer database is updated to reflect the transaction, including any financing term that applies thereto.

Updating the buyer database effectively closes the loop so that the next time the buyer visits the seller's website, the seller would have the latest data and know what financing terms were offered to the buyer in the past. This knowledge helps the seller tailor his offerings, including finance term offerings, to the buyer to improve customer satisfaction. This data also helps the seller optimize the triggering condition such that the desired buyer behavior is achieved with the minimum cost possible or a lower cost to the seller in terms of financing incentives.

As mentioned earlier, the default financing term, the triggering condition or triggering conditions, and the various alternative financing terms and/or rewards may be tailored to each individual buyer based on any legitimate business reason. For example, an important buyer may be given a better default financing term than other buyers based on his importance to the seller organization. Further, the buyer may be given a different set of triggering conditions than the set of triggering conditions offered to other buyers. Likewise, that buyer may have a different set of alternative financing terms and/or other rewards compared to the set of alternative financing terms and/or other rewards offered to other buyers. Since the data mining and data analysis on buyers are performed electronically and in a frictionless manner, it is possible to tailor the finance offerings to each individual buyer to better retain the buyer and/or encourage a desired buying behavior.

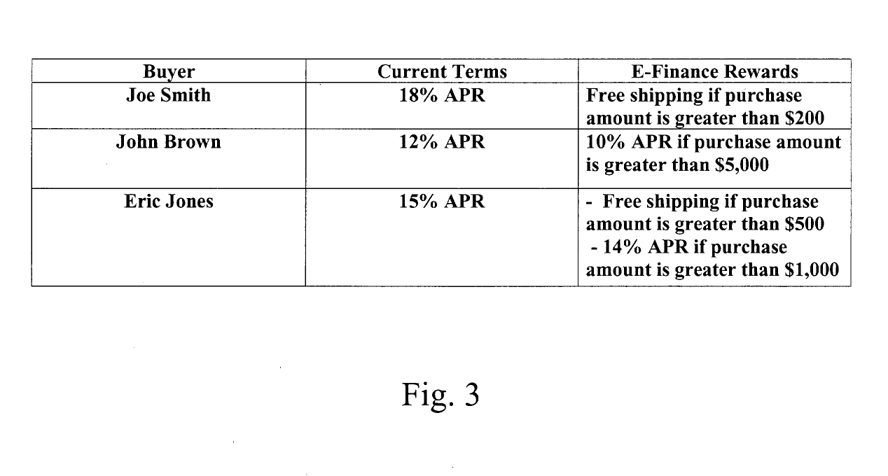

FIG. 3 is an exemplary table showing three different buyers having three different default financing terms (APRs in the example of FIG.3). Furthermore, these three different buyers may be given different rewards in terms of alternative financing terms, and/or other rewards, as well as different triggering conditions to obtain those rewards.

As can be appreciated from the foregoing, by employing financing terms as a competitive tool, and employing electronics to frictionlessly track and analyze the buyer's past and current buying and selection behaviors, the invention makes it possible to timely and efficiently tailor financing terms to individual buyers to encourage a particular buying behavior desired by the seller, to improve buyer satisfaction, improve buyer retention, and/or increase sales volume and inventory turnover.

In accordance with another embodiment of the present invention, there is provided a computer-implemented group purchase incentive technique to encourage repeat and/or volume buyers to return to the seller's secure e-commerce website and/or to make larger purchases. It is observed that certain buyers buy in large quantities and/or in high dollar amounts relative to the quantity and/or dollar amount generally associated with personal consumption, either because they have a greater-than-norm need for the goods/services offered or they make purchases on behalf of others (such as on behalf of an organization or a group of individuals). These buyers represent a highly important group of buyers, and it is imperative to improve their satisfaction and loyalty while discouraging these buyers from bargain shopping elsewhere.

In accordance with one embodiment of the present invention, when a buyer is recognized as having been a volume buyer in the past (in terms of quantity or dollar amount), the computer-implemented method automatically offers incentives to reward that buyer in the current transaction and/or to encourage a larger purchase. In one embodiment, the incentives are offered as soon as the customer is recognized as a past volume buyer. In another embodiment, the incentives are offered based on the goods/services selected for purchase by the volume buyer in the current transaction. Furthermore, if a buyer is not recognized as a volume buyer in the past but may be qualified as a volume buyer in the future based on the quantity and/or dollar volume of the current transaction, an incentive redeemable in a future transaction may be offered in the current transaction. The future incentive may be, for example, a coupon that offers a discount redeemable in a future transaction. The coupon itself may optionally have quantity and/or dollar volume restrictions associated with a future transaction or future transactions.

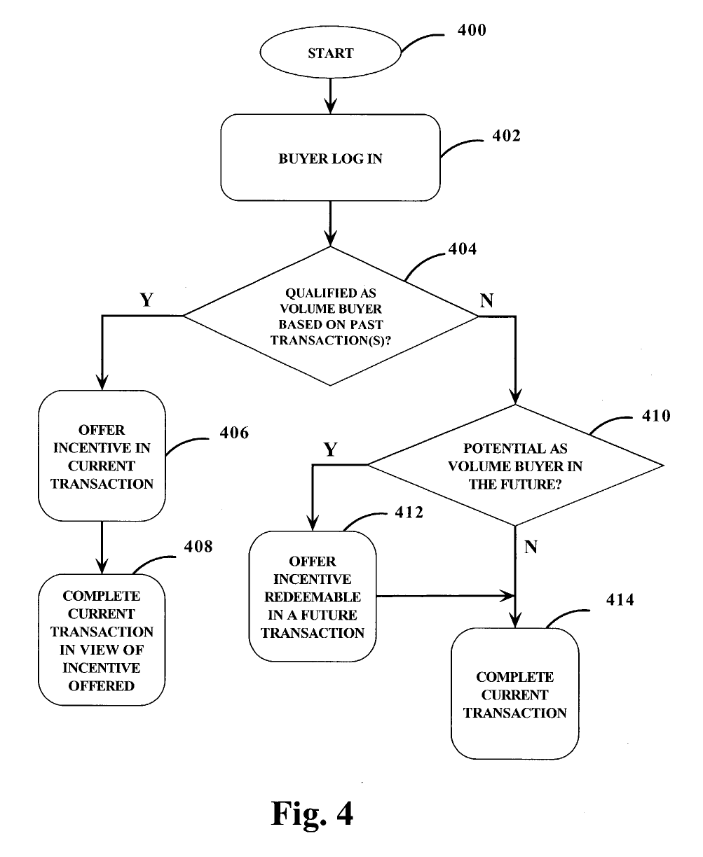

FIG. 4 is a flowchart illustrating, in accordance with one embodiment of the present invention, the computer-implemented group purchase incentive technique. In FIG. 4, the buyer may identify himself to the electronic commerce system by logging in step 402. If this is a new buyer, step 402 may represent, for example, the registration step. In step 404, the electronic commerce system consults a buyer database to ascertain whether the buyer identified via step 402 is a volume buyer. In one embodiment, a threshold in terms of quantity and/or dollar amount may be employed to ascertain whether the buyer's past transaction or transactions would qualify the buyer as a volume buyer. Different thresholds may optionally exist for different types and/or classes of buyers, or for different product classes or products. For example, while a past purchase volume of 3 computer monitors may not qualify a buyer as a volume buyer, a past purchase volume of 3 photocopiers may very well qualify that buyer as a volume buyer.

If the buyer is ascertained to be a volume buyer based on past transaction or transactions (as determined in block 404), an incentive is offered in block 406. The incentives offered can be in the form of, for example, a discount, free merchandise, free shipping, a lower than default interest rate as discussed earlier herein, and/or the like. The incentives may be offered at the checkout point in the current transaction, or it may be offered up front to stimulate the buyer's interest in particular products, particular classes of products, or a transaction of a certain quantity or dollar volume. The incentives are calculated to promote additional buying in the current transaction and/or to improve customer satisfaction and loyalty. In step 408, the present transaction is conducted in view of the offered incentive until completion.

On the other hand, if the buyer is not recognized as a volume buyer based on a past purchase transaction or purchase transactions (as determined in block 404), the buyer's current transaction may be examined to determine if that buyer may qualify as a volume buyer in the future based on the quantity and/or dollar volume associated with the current transaction (410). This determination may be made before, during, or after the checkout process is completed for the current transaction. In one embodiment, the determination may be made even before the selection of any purchase by the buyer if data analysis based on the buyer's registration information suggests that the buyer has the potential to be a volume buyer.

If the buyer is deemed to have the potential to be a volume buyer, an incentive redeemable in a future transaction may be offered (412). As mentioned, the future incentive may be, for example, a coupon that offers an incentive redeemable in a future transaction and may optionally have quantity and/or dollar volume restrictions associated with a future transaction or future transactions. Thereafter, the transaction proceeds as normal (414).

On the other hand, if the buyer is neither recognized as a volume buyer based on past transactions nor deemed to have the potential to be a volume buyer based on registration data and/or the current transaction, that buyer's current transaction proceeds as normal (414).

As can be appreciated from the foregoing, the disclosed computer-implemented group purchase incentive technique advantageously ensures that volume buyers, who are buyers highly valued to the seller, are satisfied and/or incentives to stay loyal. By receiving the incentives, the volume buyer is motivated to return to the seller's site for future purchases and/or to make larger purchases. The knowledge that an incentive may be offered also discourages the tendency to shop around for bargains, thereby further enhancing customer retention.

While this invention has been described in terms of several preferred embodiments, there are alterations, permutations, and equivalents which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer-implemented method for conducting an electronic commerce transaction between a buyer and a seller, said electronic commerce transaction being conducted via a telecommunication network, comprising:
receiving identity information pertaining to said buyer;
ascertaining a set of financing terms associated with said buyer, said set of financing terms including at least a first interest rate, a triggering condition, and a second interest rate lower than said first interest rate, said triggering condition pertaining to at least one parameter associated with said electronic commerce transaction;
ascertaining whether said electronic commerce transaction satisfies said triggering condition; and
if said triggering condition is satisfied by said electronic commerce transaction, applying said second interest rate to a financing amount, at least a portion of said financing amount being attributable to said electronic commerce transaction, else applying said first interest rate to said financing amount if said triggering condition is not satisfied by said electronic commerce transaction.

2. The computer-implemented method of claim 1 wherein said triggering condition is a first threshold value, said triggering condition being satisfied by said electronic commerce transaction if a total purchase price associated with said electronic commerce transaction exceeds said first threshold value.

3. The computer-implemented method of claim 2 wherein said first threshold value is obtained through an analysis of past transactions by said buyer.

4. The computer-implemented method of claim 2 wherein said first threshold value is obtained through an analysis of past transactions by said buyer and data associated with said electronic commerce transaction.

5. The computer-implemented method of claim 2 wherein said first threshold value is obtained through an analysis of data associated with said electronic commerce transaction.

6. The computer-implemented method of claim 1 wherein said first threshold value is dynamically determined during said electronic commerce transaction.

7. The computer-implemented method of claim 6 wherein said first threshold value depends on said total purchase price of said electronic commerce transaction.

8. The computer-implemented method of claim 1 wherein said triggering condition relates to a specific offering by said seller, said triggering condition being satisfied by said electronic commerce transaction if said electronic commerce transaction includes a purchase of said specific offering.

9. The computer-implemented method of claim 8 wherein said specific offering represents a class of item offered for sale.

10. The computer-implemented method of claim 8 wherein said specific offering is a specific item offered for sale.

11. The computer-implemented method of claim 8 wherein said specific offering is a specific class of services offered by said seller.

12. The computer-implemented method of claim 8 wherein said specific offering is a specific service offered by said seller.

13. The computer-implemented method of claim 1 wherein at least said triggering condition and said second interest rate are provided to said buyer prior to a selection phase by said buyer, said selection phase representing a selection of at least one of goods and services by said buyer.

14. A computer-implemented method for conducting an electronic commerce transaction between a buyer and a seller, said electronic commerce transaction being conducted via a telecommunication network, comprising:
receiving identity information pertaining to said buyer;
ascertaining a set of financing terms associated with said buyer, said set of financing terms including at least a first financing term, a plurality of triggering conditions, and a plurality of alternative financing terms, each alternative financing term in said plurality of alternative financing terms being more favorable to said buyer than said first financing term;
ascertaining whether said electronic commerce transaction satisfies at least one triggering condition of said plurality of triggering conditions; and
if said electronic commerce transaction satisfies said at least one triggering condition of said plurality of triggering conditions, applying an alternative financing term associated with said at least one triggering condition satisfied by said electronic commerce transaction to at least a portion of a financing amount attributable to said electronic commerce transaction, said alternative financing term associated with said at least one triggering condition satisfied by said electronic commerce transaction being an alternative financing term of said plurality of alternative financing terms, else applying said first financing term to said financing amount.

15. The computer-implemented method of claim 14
wherein said plurality of triggering conditions includes a first triggering condition and a second triggering condition, said first triggering condition being satisfied by said electronic commerce transaction when a total purchase amount associated with said electronic commerce transaction exceeds a first threshold value, said second triggering condition being satisfied by said electronic commerce transaction when said total purchase amount associated with said electronic commerce transaction exceeds a second threshold value, said second threshold value being higher than said first threshold value, and
wherein said plurality of alternative financing terms including a first alternative financing term and a second alternative financing term, said first alternative financing term including a first interest rate associated with said first triggering condition, said second alternative financing term including a second interest rate associated with said second triggering condition, said second interest rate being lower than said first interest rate.

16. The computer-implemented method of claim 15 wherein said first threshold value is obtained through an analysis of past transactions by said buyer.

17. The computer-implemented method of claim 15 wherein said first threshold value is obtained through an analysis of past transactions by said buyer and data associated with said electronic commerce transaction.

18. The computer-implemented method of claim 15 wherein said first threshold value is obtained through an analysis of data associated with said electronic commerce transaction.

19. The computer-implemented method of claim 14 wherein said first threshold value is dynamically determined during said electronic commerce transaction.

20. The computer-implemented method of claim 14 wherein at least one of said first triggering condition and said second triggering condition is provided to said buyer prior to a selection phase by said buyer, said selection phase representing a selection of at least one of goods and services by said buyer.

21. An article of manufacture comprising a program storage medium having computer readable code embodied therein, said computer readable code being configured for conducting an electronic commerce transaction between a buyer and a seller, said electronic commerce transaction being conducted via a telecommunication network, comprising:
computer readable code for receiving identity information pertaining to said buyer;
computer readable code for ascertaining a set of financing terms associated with said buyer, said set of financing terms including at least a first interest rate, a triggering condition, and a second interest rate lower than said first interest rate, said triggering condition pertaining to at least one parameter associated with said electronic commerce transaction;
computer readable code for ascertaining whether said electronic commerce transaction satisfies said triggering condition; and
computer readable code for applying, if said triggering condition is satisfied by said electronic commerce transaction, said second interest rate to a financing amount, at least a portion of said financing amount being attributable to said electronic commerce transaction, else applying said first interest rate to said financing amount if said triggering condition is not satisfied by said electronic commerce transaction.

22. The article of manufacture of claim 21 wherein said triggering condition is a first threshold value, said triggering condition being satisfied by said electronic commerce transaction if a total purchase price associated with said electronic commerce transaction exceeds said first threshold value.

23. The article of manufacture of claim 22 wherein said first threshold value is obtained through an analysis of past transactions by said buyer.

24. The article of manufacture of claim 22 wherein said first threshold value is obtained through an analysis of past transactions by said buyer and data associated with said electronic commerce transaction.

25. The article of manufacture of claim 21 further comprising computer readable code for dynamically determining said first threshold value during said electronic commerce transaction.

26. A computer-implemented method for conducting an electronic commerce transaction between a buyer and a seller, said electronic commerce transaction being conducted via a telecommunication network, comprising:
receiving identity information pertaining to said buyer;
ascertaining, based on past transactions conducted by said buyer with said seller, whether said buyer qualifies as a volume buyer;
if said buyer qualifies as said volume buyer based on said past transactions, offering an incentive redeemable by said buyer in said electronic commerce transaction.

27. The computer-implemented method of claim 26 wherein said incentive redeemable by said buyer in said electronic commerce transaction includes a first interest rate applied to a financing amount associated with said electronic transaction, said first interest rate being lower than a second interest rate, said second interest rate representing an interest rate applicable to said buyer if said buyer had not qualified as said volume buyer.

28. The computer-implemented method of claim 26 further comprising:
if said buyer does not qualify as said volume buyer based n said past transactions, ascertaining whether said buyer qualifies as a potential volume buyer in the future;
if said buyer qualifies as a potential buyer in the future, offering an incentive redeemable in a future electronic commerce transaction between said buyer and said seller.

29. The computer-implemented method of claim 28 wherein said ascertaining whether said buyer qualifies as said potential volume buyer includes an analysis of said electronic commerce transaction.

30. The computer-implemented method of claim 30 wherein said incentive redeemable by said buyer in said electronic commerce transaction includes one of a free merchandise and a discount amount.

31. The computer-implemented method of claim 26 wherein said ascertaining includes analyzing at least one of a quantity parameter and a dollar volume parameter associated with at least one of said past transactions.
